(19) United States
(12) Patent Application Publication
(10) Pub. No.: US 2020/0182308 A1
(43) Pub. Date: Jun. 11, 2020

(54) Self-Adjusting Armature Assembly

(71) Applicant: Eaton Intelligent Power Limited, Dublin (IE)

(72) Inventor: Michael Hornbrook, Orland, IN (US)

(73) Assignee: Eaton Intelligent Power Limited, Dublin (IE)

(21) Appl. No.: 16/639,784

(22) PCT Filed: Aug. 19, 2018
(86) PCT No.: PCT/IB2018/056263

§ 371 Date: Feb. 18, 2020

Related U.S. Application Data
(60) Provisional application No. 62/547,144, filed on Aug. 18, 2017.

(51) Int. Cl. F16D 27/04; F16D 27/112; F16D 27/14; F16D 48/06

(52) U.S. Cl. CPC F16D 27/04; F16D 27/112; F16D 2027/007; F16D 48/064; F16D 27/14

(57) ABSTRACT

An adjustable armature assembly (100) comprises an armature hub (300) configured to couple to a shaft, the armature hub (300) comprising a cover side and a plate side. An armature plate (400) can be movable with respect to the armature hub (300), the armature plate (400) comprising at least one pin-receiving hole (460), the pin-receiving hole (460) positioned to face the plate side of the armature hub (300). A spring assembly (500) can couple the plate side of the armature hub (300) to the armature plate (400). A control pin (650) can be mounted in the pin-receiving hole (460), the control pin (460) comprising a control pin head extending out of the pin-receiving hole (460). The armature plate (400) is configured to irreversibly walk out away from the armature hub (300) when the armature assembly (100) is engaged.

### FIELD

This application relates to clutch armature assemblies.

### BACKGROUND

In the typical configuration of an electromagnetic clutch, the clutch rotor and clutch armature are held in fixed positions, with the armature plate being held mechanically by a series of return springs. As the clutch is engaged the magnetic field overcomes the return springs and pulls the armature against the clutch rotor. Over time, due to loss of friction material, the gap between the armature and clutch rotor will increase to the point where the magnetic field cannot overcome the return spring force and the clutch will fail to engage. This effect greatly reduces the usable life of an electromagnetic clutch.

### SUMMARY

The methods and devices disclosed herein overcome the above disadvantages and improves the art by way of an adjustable armature assembly.

An adjustable armature assembly comprises an armature hub configured to couple to a shaft, the armature hub comprising a cover side and a plate side. An armature plate can be movable with respect to the armature hub, the armature plate comprising at least one pin-receiving hole, the pin-receiving hole positioned to face the plate side of the armature hub. A spring assembly can couple the plate side of the armature hub to the armature plate. A control pin can be mounted in the pin-receiving hole, the control pin comprising a control pin head extending out of the pin-receiving hole. The armature plate is configured to irreversibly walk out away from the armature hub when the armature assembly is engaged.

The adjustable armature assembly can further comprise a control lock disc coupled between the armature hub and the armature plate, wherein the control lock disc comprises a pin hole, and wherein the control lock disc is mounted to reciprocate on the control pin via the pin hole. The armature hub can comprise a neck with an outer surface. The outer surface can be ribbed. The control lock disc can comprise an annular body and an interior flange. The armature plate can be configured to irreversibly walk out away from the armature hub by pulling the control pin head against the control lock disc and walking the flange over the ribbed outer surface when the armature assembly is engaged.

An adjustable armature assembly can comprise an armature hub comprising a coupling plate comprising a cover side, a plate side, and a port through the coupling plate from the cover side to the plate side. An armature plate is movable with respect to the armature hub. The armature plate comprises at least one pin-receiving hole. The pin-receiving hole is positioned to face the plate side of the armature hub. A spring assembly couples the plate side of the armature hub to the armature plate. A control pin mounts in the pin-receiving hole and through the port. The control pin comprises a control pin head extending out of the port. A control lock washer couples to the control pin and is configured to selectively abut the cover side of the armature hub. A cover is coupled to the cover side and is configured to provide a space for the control lock washer to move between a first position abutting the cover and a second position abutting the second side of the armature hub.

The adjustable armature assembly can be configured for use in a clutch assembly comprising a rotor assembly configured for rotation and a magnet assembly configured to attract the armature plate towards the rotor assembly.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIGS. 1A & 1B are views of a self-adjusting armature assembly.

FIG. 2 is a partially exploded view of the armature assembly.

FIG. 3 is an exploded view of the armature assembly.

FIG. 4 is a cross-section view of an example of a clutch assembly.

FIG. 5 is a view of an armature assembly in a new condition.

FIG. 6 is a view of the armature assembly in a first engaged condition.

FIG. 7 is a view of the armature assembly in a first disengaged condition.

FIG. 8 is a view of the armature assembly in a second engaged condition.

FIG. 9 is a view of the armature assembly in a second disengaged condition.

FIG. 10 is a view of lock washer.

FIG. 11 is an exploded view of an alternative self-adjusting armature assembly.

FIG. 12 is a cross-section view of the alternative armature assembly.

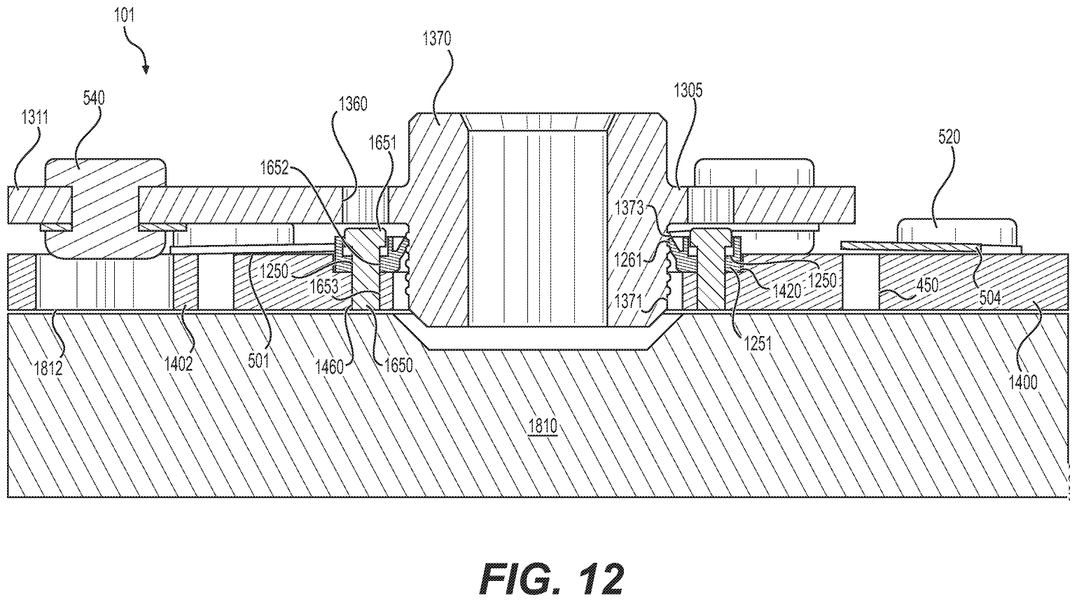

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

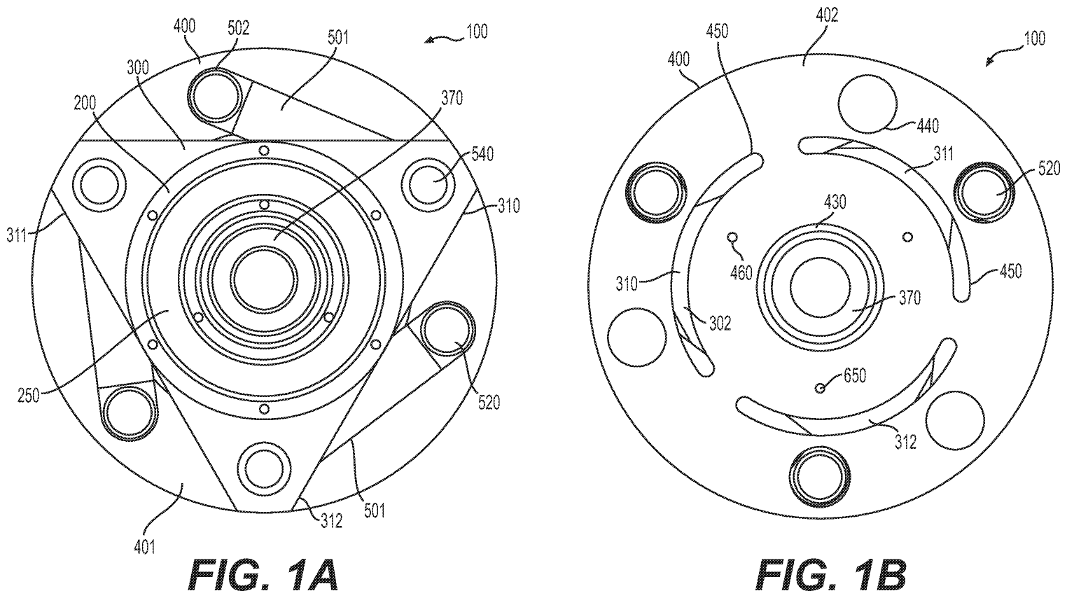

FIG. 1A shows a rear side of an armature assembly 100 and FIG. 1B shows a rotor side of the armature assembly 100. On the rear side, a cover 200 is seated around a neck 370 of a hub 300. Neck 370 can extend from the cover side 301 and from the plate side 302. Cover 200 can be screwed, nailed, welded, or otherwise secured to the cover side 301 of the hub 300 and is shown with holes for fasteners. Drive straps or springs 501 or spring assemblies 500 are connected at first ends 502 to an armature plate 400 by rivets, also called armature rivets 520. At second ends 504, drive straps or springs 501 of the spring assemblies 500 are connected to respective arms 310, 311, 312 of the hub 300 by rivets 540. The arms 310-312 are illustrated as forming a pyramidal appearance for the coupling plate 305, though other shapes for the arms, such as notched, serpentine, semi-circular, among others, can be substituted.

Armature plate 400 can be designed with a hub side 401 facing the hub 300 and with a coupling side 402 for facing a coupling surface comprising one or more friction fingers 811 of a rotor assembly 810 of a power assembly 800. A hub hole 430 can provide clearance around the portion of the neck 370 that extends toward the armature plate 400. Slots 450 can be included in or through the armature plate 400 for functions such as collecting debris, collecting worn friction material, or controlling flexure of the armature plate. Rivet seating holes 440 can be formed for receiving nubs of the rivets, also called hub rivets 540. Rivet holes 420 can be formed for receiving the armature rivets 520. Armature rivets 520 and hub rivets 540 can be optionally rubberized, can be dog-bone or door-knob shaped among others, and can optionally be configured as dampers or bumpers. In the example of FIG. 1B, pin receiving holes 460 are formed through the armature plate 400 for receiving control pins 650 of the control lock washer assembly 600. In other Figures, the pin receiving holes 461 do not pass through the armature plate 400.

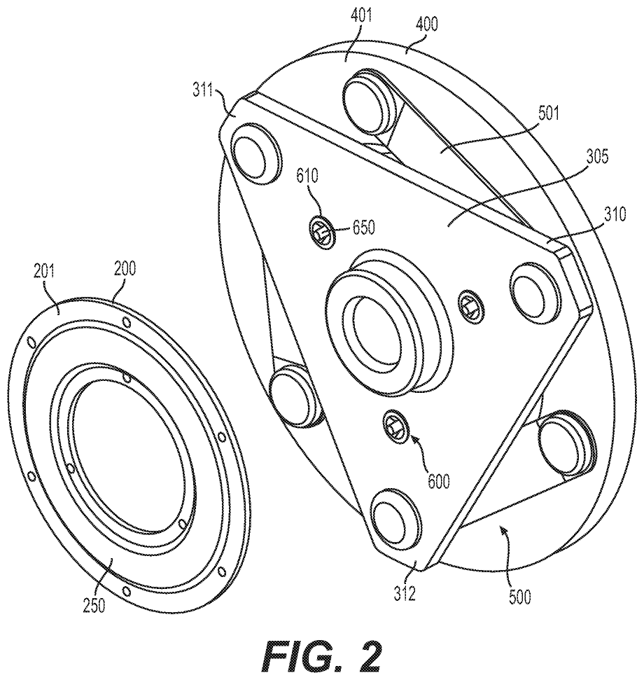

In FIG. 2, control lock washer assemblies 600 are shown placed with respect to the cover side 301 of the hub 300. Control lock washers 610 are seated in washer-seating ports 360 that extend through the coupling plate 305 of the hub 300. The control pin 650 protrudes out from the control lock washers 610. The number of the control lock washer assemblies 600 is not limited to 3, and can be 1, 2, 4, among other design choices. The location of the control lock washer assemblies 600 can also be adjusted and need not be limited to one per respective hub arm 310-312 circumscribing the neck 370. The port 360 can be sized and shaped to constrain the control lock washer assemblies 600 from jiggling, as by comprising stepped features for conforming to one or more of the control pin 650, the dome 630, or the lip 620.

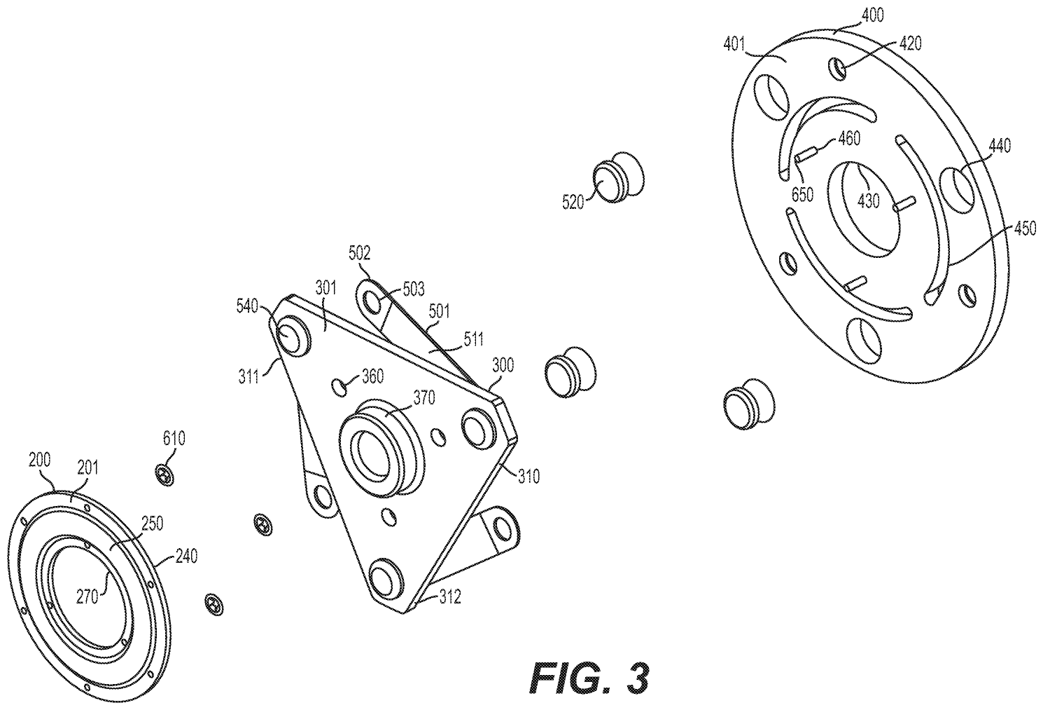

FIG. 3 shows another exploded view of the adjustable armature assembly 100 comprising an armature hub 300 configured to couple to a shaft via neck 370. The armature hub comprising a coupling plate 305, the coupling plate comprising a first side (cover side) 301, a second side (plate side) 302, and at least one port 360 through the coupling plate 305 from the first side (cover side 301) to the second side (plate side 302). An armature plate 400 is movable with respect to the armature hub 300. Armature plate 400 comprises at least one pin-receiving hole 460, the pin receiving hole positioned to face the first side of the armature hub.

A spring assembly 500 comprised of a spring 501 and rivets 540, 520 couples the plate side 302 of the armature hub 300 to the hub side 401 armature plate 400. Spring 501 can be a drive strap or return spring. The spring assembly 500 can comprise a spring 501 comprising a body 511 and a first end, or armature end, 502 having a hole 503 for receiving an armature rivet 520. Spring 501 can comprise a second end, or hub end, 504 comprising a hole 505 for receiving rivet 540. The body 511 can be configured to elastically deform or flex so that the armature plate 400 can be moved with respect to the hub 300 and so that the springs 501 urge or bias the armature plate 400 to return toward the hub 300.

A control lock washer assembly 600 is in exploded view. A control pin 650 is mounted in the pin-receiving hole 460, the control pin extending through the at least one port 360 so that a portion of the control pin 650 extends out of the cover side 301 of the armature hub 300. A control lock washer 610 is coupled to the control pin 650 and is configured to selectively abut the cover side 301 of the armature hub 300.

A cover 200 can be coupled to the cover side 301 and configured to provide a space 260 for receiving portions of the control lock washer assembly 600. The cover 200 can comprise a step 261 in the space 260 for restricting motion of the control lock washer 610. The cover 200 can be stamped, molded, crimped, grooved, or otherwise formed to include the step 261, coupling rims 240, 270, holes, and space 260. The control lock washer 610 can move between a first position abutting the step 261 in the cover 200 and a second position abutting the cover side 301 of the armature hub 300. The cover side 301 can also be stepped for restricting the motion of the control lock washer 610. While the lip 620 of the control lock washer 610 can be restricted by the step 261 in the cover 200 and by the cover side 301, the control pin 650 projects a portion in to the space 260.

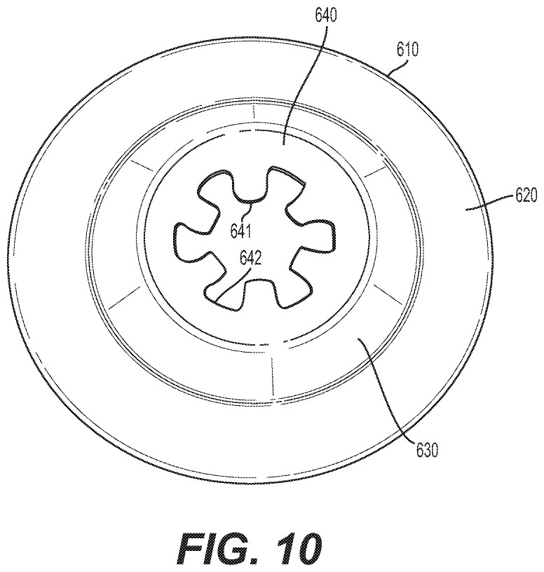

As shown in FIG. 10, the control lock washer 610 can comprise a control ring comprising teeth 641 for gripping the control pin 650. The control ring can comprise a dome 630 and grip area 640. The grip area 640 can comprise teeth 641 and spacings 642 therebetween. The teeth 641 and spacings 642 can be a variety of shapes and a variety in number and are not restricted to the example illustrated. For example, triangular teeth and triangular spaces can be used, or rectilinear teeth and spacings, among other alternatives. Six teeth 641 and six spaces 642 are drawn, but 8 or more teeth and spaces can be used, or 2 or 4 teeth and spaces can be used so long as adequate holding strength on the control pin 650 is achieved so that the control pin 650 does not walk backwards through the control lock washer 610. The shape of the dome 630 can be a convex shape to facilitate one-way travel of the control pin 650 through the control ring. The grip area 640 can be flat or can be domed, with flat or curved or sloping teeth 641.

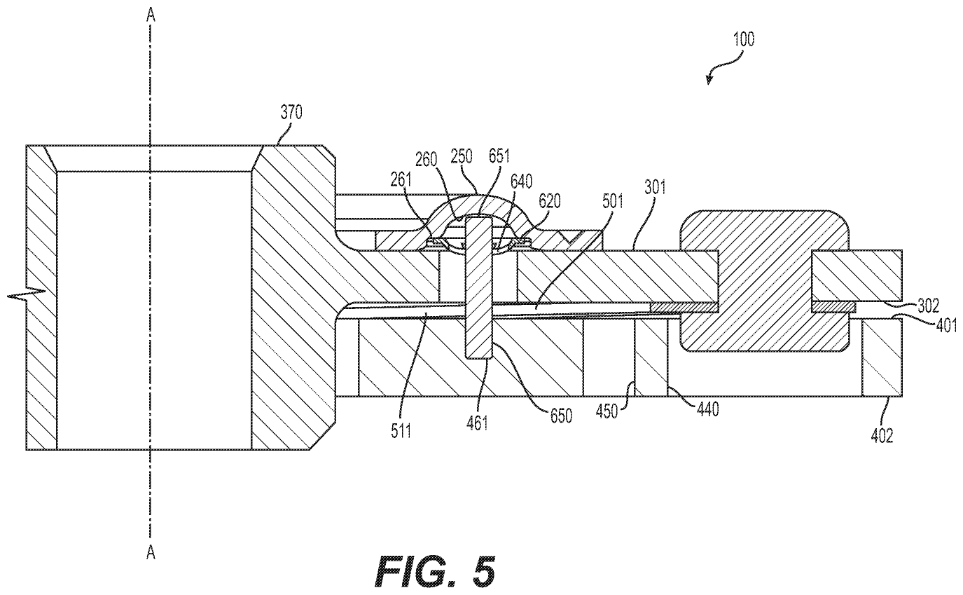

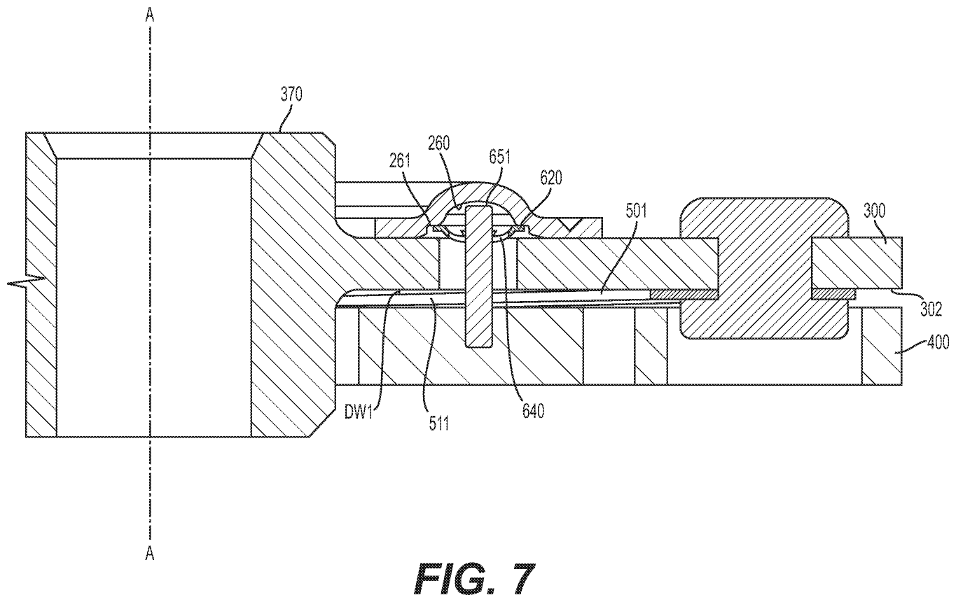

As discussed in more detail, the control pin 650 is gripped in the control lock washer 610 to set the distance between the armature hub 300 and the armature plate 400. The distance between the armature hub 300 and the armature plate 400 can be increased from a baseline distance (shown in FIG. 5) to various walk-out distances (shown in FIGS. 7 & 9) by moving the control pin 650 with respect to the control lock washer 610. The armature plate 400 pulls on the control pin 650 when the armature plate is engaged. The control pin 650 can move in one direction, flexing the teeth 641. But force in the opposite direction, when the armature plate 400 is disengaged, causes the teeth to bite in to the control pin and halt backwards travel of the control pin 650. The control lock washer 610 can be designed of a harder material than the control pin 650. The armature plate is thus configured to irreversibly walk out away from the armature hub by pulling the control pin through the control lock washer when the armature assembly is engaged.

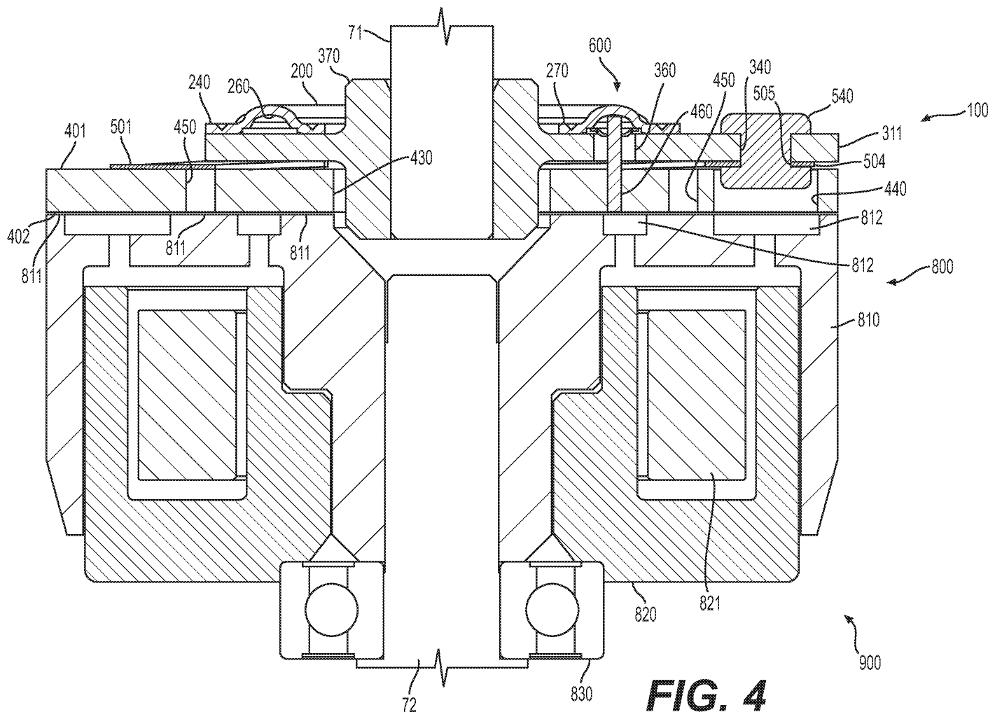

Turning to FIG. 4, the armature assembly 100 is shown integrated in to a clutch assembly 900. A power assembly 800 comprises a rotor assembly 810 and a stator in the form of a magnet assembly 820 affixed to an input shaft 72 at a ball bearing assembly 830. The magnet assembly 820 comprises a magnet coil 821. The input shaft 72 can be rotated by another source or torque, or the magnet assembly 820 can be configured to induce rotation of the rotor assembly 810. The rotor assembly 810 can be formed to surround the stator 820. The power assembly 800 uses the magnet assembly 820 for one or both of rotating the rotor assembly 810 and attracting the armature plate 400 towards the rotor assembly 810.

The rotor assembly 810 can comprise a coupling surface in the form of one or more friction fingers 811 separated by control channels 812. Forming a stepped pattern on the coupling surface can control the grip between the armature plate 400 and the rotor assembly 810 for transferring torque from the input shaft 72 to the output shaft 71 that is coupled to the armature assembly 100. Various friction materials can be applied to one or both of the coupling surface of the rotor assembly 810 and coupling side 402 of the armature plate 400. Texturing, as by scoring, stippling, or stamping, among others, can alternatively or additionally be applied to one or both of the coupling surface and the coupling side 402 so as to constitute a friction material. The armature assembly can self-adjust as by the armature plate irreversibly walking out away from the armature hub when the friction material of the coupling side 402 armature plate or the coupling surface of the rotor assembly 810 wears down.

Alternative power assemblies can be used in conjunction with the armature assembly 100 and the armature assembly is not restricted to use with only the example of FIG. 4. For example, other flux patterns can be induced in the rotor and stator assembly, or various stacked plates can be arranged for transferring torque, such as an arrangement permitting a neutral condition. The armature assembly is particularly useful in supercharger applications to supply rotational force to rotors within the device to blow or compress air. The self-adjusting armature assembly 100 can be used in a variety of electromagnetic clutch or brake devices to maintain a fixed air gap and extend the life thereof. It is well suited for driven devices, such as superchargers, alternators, compressors, pumps, fan devices, among many others.

The armature assembly 100 is configured to maintain a coupling distance between the armature plate 400 and the rotor assembly 810 as by gripping the control pin 650 in the control lock washer 610.

The armature plate 400 is movable with respect to an armature hub 300. The armature hub 300 can be secured to an output shaft 71. In the example of a supercharger application, the output shaft 71 is coupled directly or indirectly through a transfer case to one or more rotor shafts of the rotating portion of the supercharger, typically lobed rotors.

The armature hub 300 is rigidly fixed to the output shaft 71 so as to remain in a constant position with respect to the output shaft 71. The armature plate 400 is mounted movably so that the magnetic attraction of the magnet assembly pulls the armature plate 400 away from the armature hub 300 and towards the coupling surface of the rotor assembly 810 for torque transfer from the rotor assembly to the armature plate 400. When there is no magnetic attraction, a spring force from springs 501 can pull the armature plate 400 back towards the armature hub 300 to decouple the output shaft 71 from receiving torque from the input shaft 72 of the power assembly 800. The rotor assembly 810 and magnet assembly 820 are typically positionally axially fixed with respect to the input shaft so that they cannot move along the input shaft 72 towards the output shaft 71. Rotating the rotor assembly 810 around the input shaft 72 is permitted.

The Figures explain that a new armature assembly 100, and hence a new clutch, has a baseline distance between the armature hub 300 and armature plate 400. The armature plate 400 has a coupling distance between itself and the coupling surface of the rotor assembly 810. The coupling surface of the rotor assembly and or the armature plate can comprise a friction material that wears down over time, increasing the coupling distance. The increased coupling distance limits the reach of the magnetic field, making it harder for the rotor to couple to the armature assembly.

By applying the aspects disclosed herein, the coupling distance can be maintained over time, as the friction material wears down, as by increasing the baseline distance to a wear-down distance. The control lock washer 610 and control pin 650 in the Figures facilitates this.

The control lock washers 610 can be seated in a space 260 between the armature hub 300 and cover 200. Grooves, stampings, or other locating features can be included. The control lock washers 610 can move parallel to the axis A-A. Axis A-A is illustrated as the axis about which the input and output shafts 71, 72 rotate. The control lock washers 610 can move a distance similar or the same as the coupling distance between the coupling surface and the coupling side 402 of the armature plate 400. When the clutch is engaged, a lip 620 of the control lock washer 610 is pulled against the armature hub 300. When the clutch is disengaged, the lip 610 of the control lock washer 610 seats against the cover 200, which can comprise a locating step 261.

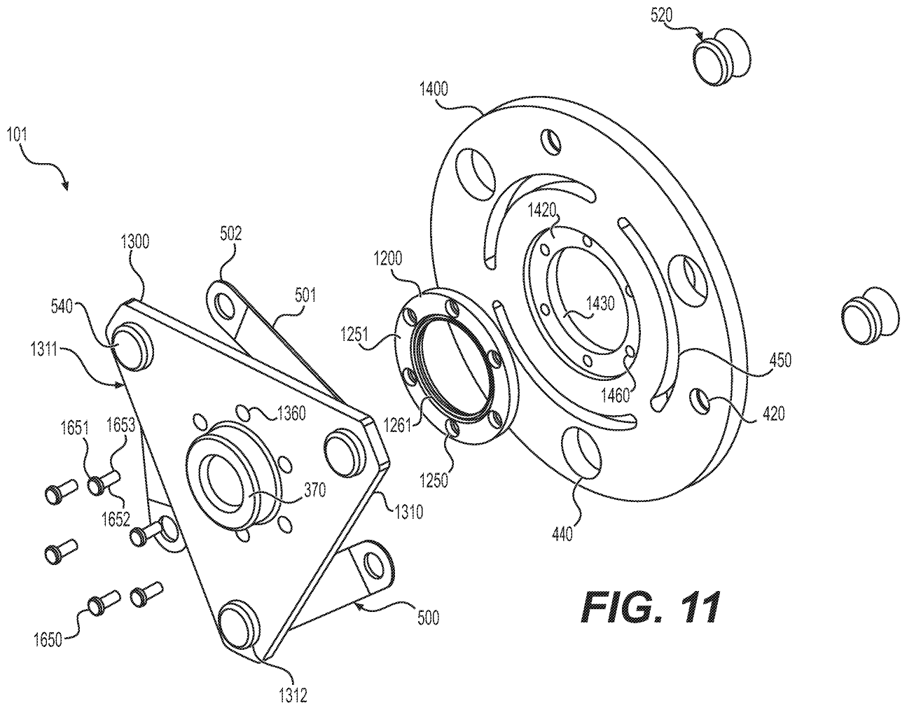

Alternatively, instead of three loose pieces for the control lock washers 610, the control lock washers 610 can be integrally formed in a unitary ring assembly with the ring assembly secured between the armature hub 300 and the cover 200. Or, as shown in FIGS. 11 & 12 and discussed below, the unitary ring assembly 1200 can be secured between the hub 1300 and the armature plate 1400.

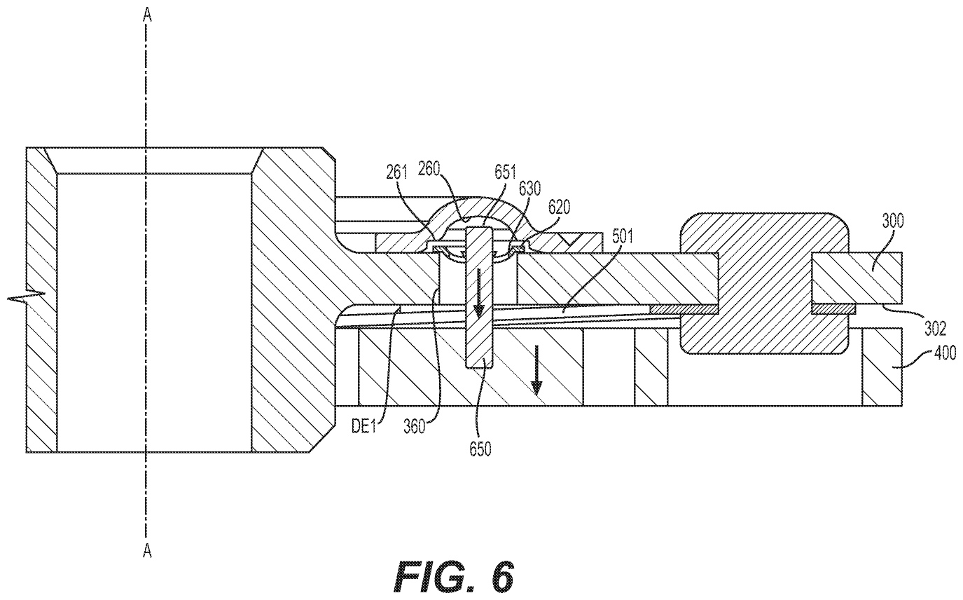

The armature plate 400 can receive control pins 650, as by press-fitting the control pins 650 into holes 460, 461. The control pins 650 can be press-fit, screwed, bonded or otherwise secured to the armature plate 400. Welding, LOCTITE, glue, among other bonding techniques can be used. The control pins 650 seat within the control lock washers 610. A control ring comprising a grip area 640 of the control lock washer 610 is designed so that teeth 641 grip the control pin. The control pin 650 can slide in one direction through the control ring grip area 640, but not the other direction. So, when the rotor assembly 810 attracts the armature plate 400, the control pin 650 can slide parallel to the axis A-A in the direction away from the cover 200, as illustrated by the thick arrows in FIGS. 6 & 8. But, the control pin 650 cannot slide back towards the cover 200. This increases the distance between the armature plate 400 and the armature hub 300 from the baseline distance. The configuration can be designed to offer a range of adjustments, or walk-out distances, that the armature plate 400 can walk away from the armature hub 300. Then the magnetic forces from the coil assembly 821 can reach the armature plate 400 consistently.

To avoid obfuscating the features of the invention, a baseline distance of a new armature assembly 100 can be seen in the gap between the body 511 of the spring 501 and the plate side 302 of the coupling plate 305 in FIG. 5. The head 651 of the control pin 650 abuts or nearly abuts a step-out 250 in cover 200. The step-out 250 forms the space 260 for the control lock washer assembly 600 and protects it from debris and disturbance. In a passive, disengaged state, the lip 620 of the control lock washer abuts the step 261, and the step 261 acts as a cover stop.

When the armature assembly 100 is engaged by the power assembly 800, the armature plate 400 is drawn towards the rotor assembly 810. The armature plate 400 moves as indicated by the thick arrow in the armature plate 400 in FIG. 6. Since the control pin 650 is anchored in the armature plate 400, the armature plate 400 pulls the control pin 650 with it when it moves. This walks the control pin 650 outward through the control lock washer 610 and it can be seen that the distance between the control pin head 651 and the step-out 250 in the cover 200 increases. Via the secure grip of the teeth 641 against the control pin 650, the control lock washer 610 also moves with the armature plate 400, and the control lock washer 610 abuts the cover side 301 of the hub 300. In this instance, the control pin 650 moves more, indicated by the thick arrow on the control pin, than the armature plate, as the control pin is walking out to calibrate the armature assembly 100. A first engagement distance DE1 is shown in FIG. 6 in the gap between the body 511 of the spring 501 and the hub 300.

When the armature assembly 100 returns to a disengage state, as in FIG. 7, as when the power assembly 800 releases the armature plate 400 from its magnetic field, the armature plate 400 cannot return to the baseline distance of FIG. 5. A walk-out distance DW1 is maintained by the control lock washer. This keeps the armature plate 400 a desired distance to the rotor assembly 810. The control pin head 651 is distanced from the step-out by the walk-out distance. The lip 620 of the control lock washer 610 is limited by the step 261 in the cover.

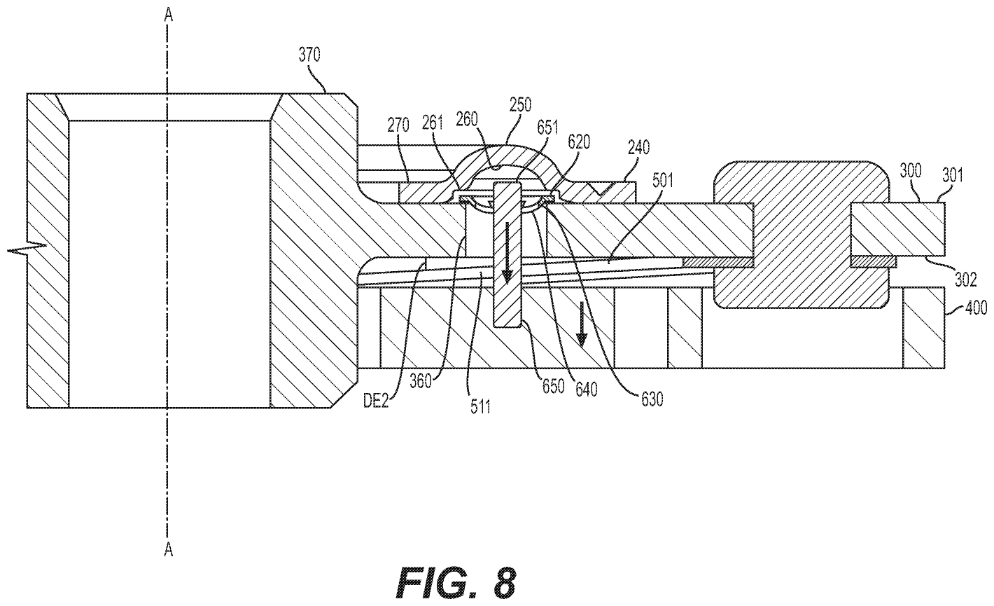

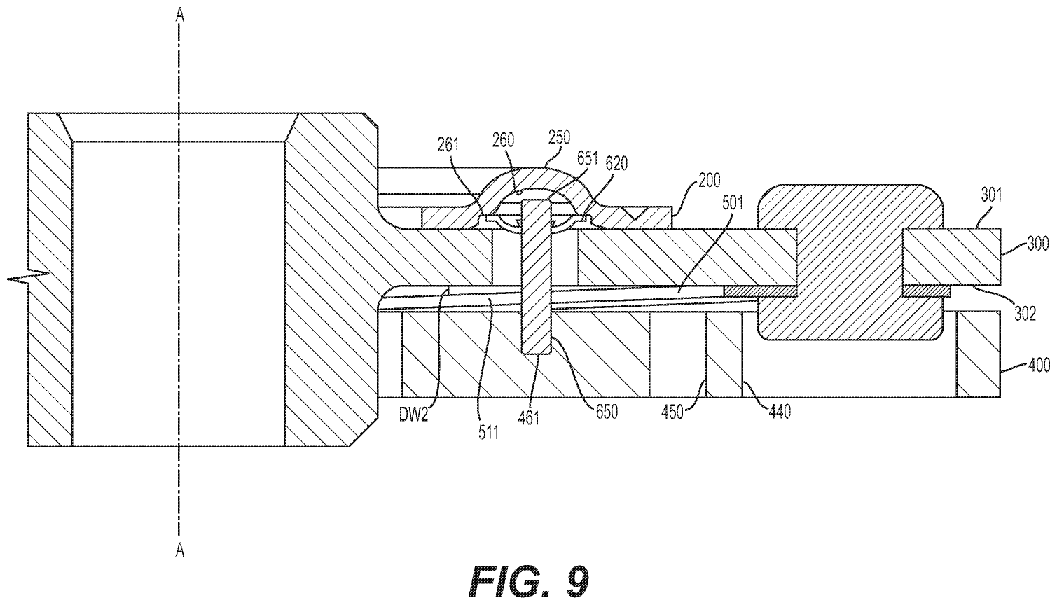

Over time, the friction material or texturing on one or both of the coupling side 402 of the armature plate 400 and the coupling surface of the one or more friction fingers 811 of the rotor assembly 810 wear down. As shown in FIG. 8, the engagement distance increases to a second engagement distance DE2 as the control pin 650 is drawn further through the grip area 640 of the control lock washer 610 when the armature plate 400 is attracted to the rotor assembly 810. The active and passive distance between the armature hub 300 and the armature plate 400 increases over the life of the armature assembly 100. Over time, the armature plate 400 moves a somewhat consistent actuation distance to couple to the rotor assembly 810 because the control pin 650 moves an aggregate walk-out distance to keep the armature plate 400 a consistent distance from the coupling surface of the rotor assembly. FIG. 9 shows the increased second walk-out distance DW2 for the armature assembly in a disengaged but worn-down state.

An alternative self-adjusting armature assembly 101 is shown in FIGS. 11 & 12. Many aspects of the armature assemblies 100 & 101 are as above and are not repeated hereinbelow. Spring assemblies 500 can comprise a drive strap or spring 501 connecting arms 1310, 1311, 1312 of the armature hub 1300 to the armature plate 1400. As above, the friction material or texturing etc. between a coupling surface 1812 of a rotor assembly 1810 and the coupling side of 1402 armature plate 1400 can wear, and this increases the gap between the rotor assembly 1810 and the armature plate 1400, making actuation more difficult. The alternative control lock disc 1200 resets the spacing between the armature plate 1400 and the coupling surface 1812.

Armature hub 1300 is modified in the area of coupling plate 305 to comprise ports 1360 for non-interference coupling with heads 1651 of control pins 1650. In a new armature assembly 101, the control pins 1650 can be installed through the ports 1360 and the heads 1651 can reciprocate out of and into the ports 1360 when the armature assembly is engaged and disengaged. The ports 1360 can be designed to receive the heads 1651 when the armature assembly 101 is disengaged. If the distance between the hub 1300 and armature plate 1400 is sufficient to accommodate the travel of the heads 1651, the ports 1360 can be omitted or shortened to non-pass through recesses.

Necks 1652 of the control pins 1650 can pass through the control lock disc 1200 and the control lock disc can comprise pin holes 1250 for reciprocating on the necks 1652 when the armature assembly selectively changes between engaged and disengaged. Ends 1653 of the control pins 1650 can attach to pin-receiving holes 1460 in the armature plate. The connection of the control pins 1650 to the pin-receiving holes 1460 can be similar to that for pin-receiving holes 460 above. The number and distribution of control pins 1650, pin holes 1250, and pin-receiving holes 1460 can vary.

Armature hub 1300 is further modified so that neck 1370 comprises an outer surface 1371 that comprises ribs 1373. Grooves, steps, notches, bumps, humps, and other patterns of projections and valleys can comprise the ribs 1373. Then, the control lock disc 1200 can comprise a flexible flange 1261 projecting towards the outer surface 1371. The flange 1261 can seat against the hub plate side 1302 or catch against a first rib 1373. Flange 1261 can be configured to walk-out to a next rib when a gap between the coupling side 1402 and the coupling surface 1812 increases and the armature plate 1400 is drawn towards the rotor assembly 1810. The space between ribs can be set to a reset distance, so that the armature plate “resets” its distance to the coupling surface of the rotor assembly when the control lock disc walks out over the ribs. Flange 1261 is also configured so that when the armature plate 1400 is disengaged and the springs 501 pull the armature plate 1400 back towards the hub 1300, the control lock disc 1200 does not walk backwards towards the hub 1300. Thus, the armature plate walks out away from the armature hub along with the control lock disc. The control pin head pulls the control lock disc when the gap increases.

Control lock disc 1200 can comprise an annular body 1251 with pin holes 1250. The pin holes 1250 can be stepped so that the head 1651 fits in a first step of the pin hole 1250 and the neck 1652 is surrounded by a second step of the pin hole 1250. The interior flange 1261 can surround a portion of the neck 1370 of the hub including outer surface 1371. The armature plate is thus configured to irreversibly walk out away from the armature hub by pulling the control pin head against the control lock disc and walking the flange over the ribbed outer surface when the armature assembly is engaged.

Armature plate 1400 can be additionally modified to comprise a recess 1420 to receive at least a portion of, if not all of, the control lock disc 1200. The control lock disc 1200 can be recessed into the recess 1420 to avoid creating an undesired gap between the hub 1300 and the armature plate 1400 while accommodating sufficient thickness for the control lock ring 1200 and its flange 1261.

Benefits of these configurations are:
Maintains air gap between armature and clutch rotor.
All features are contained within armature assembly, no modifications to clutch assembly required.
Armature is interchangeable with other clutch assemblies.
By maintaining the air gap set between the clutch armature and the clutch rotor, the usable life of the clutch device may be extended to two or three times the lifespan without the control lock washer assembly 600.
By maintaining the air gap set between the clutch armature and the clutch rotor, the control current required to engage the clutch device remains relatively constant throughout the usable life.
By maintaining the air gap set between the clutch armature and the clutch rotor, the magnetic design may be a multiple pole design to achieve torque capacity within a smaller design envelope, without sacrificing wear life (as the number of poles are increased, the torque capacity increases, but the air gap the magnetic field can overcome is decreased).

Other implementations will be apparent to those skilled in the art from consideration of the specification and practice of the examples disclosed herein.

1. An adjustable armature assembly, comprising:
an armature hub configured to couple to a shaft, the armature hub comprising a cover side and a plate side;
an armature plate movable with respect to the armature hub, the armature plate comprising at least one pin-receiving hole, the pin-receiving hole positioned to face the plate side of the armature hub;
a spring assembly coupling the plate side of the armature hub to the armature plate;
a control pin mounted in the pin-receiving hole, the control pin comprising a control pin head extending out of the pin-receiving hole,
wherein the armature plate is configured to irreversibly walk out away from the armature hub when the armature assembly is engaged.

2. The adjustable armature assembly of claim 1, further comprising:
a coupling plate integrated with the armature hub and a port through the coupling plate from the cover side to the plate side; and
a control lock washer coupled to the control pin and configured to selectively abut the cover side of the armature hub,
wherein the armature plate is configured to irreversibly walk out away from the armature hub by pulling the control pin through the control lock washer when the armature assembly is engaged.

3. The adjustable armature assembly of claim 2, further comprising a cover coupled to the cover side, the cover configured to provide a space for the control lock washer to move between a first position abutting the cover and a second position abutting the second side of the armature hub.

4. The adjustable armature assembly of claim 2, wherein the control lock washer comprises a control ring comprising teeth for gripping the control pin.

5. The adjustable armature assembly of claim 2, wherein the control lock washer comprises a dome area comprising a convex shape to facilitate one-way travel of the control pin through the teeth.

6. The adjustable armature assembly of claim 2, wherein the control pin is gripped in the control lock washer to set a distance between the armature hub and the armature plate.

7. The adjustable armature assembly of claim 2, wherein the distance between the armature hub and the armature plate can be increased from a baseline distance to a walk-out distance by moving the control pin with respect to the control lock washer.

8. The adjustable armature assembly of claim 3, wherein the cover comprises a step configured to restrict the motion of the control lock washer with respect to the cover.

9. The adjustable armature assembly of claim 8, wherein the control lock washer comprises a lip configured to complement the step.

10. The adjustable armature assembly of claim 2, wherein the control lock washer comprises a dome projecting into the port, and wherein the port is configured to restrict the motion of the control lock washer with respect to the armature hub.

11. The adjustable armature assembly of claim 1, wherein the armature plate comprises a hub side and a coupling side, wherein the coupling side comprises friction material, and wherein the armature plate irreversibly walks out away from the armature hub when the friction material wears down.

12. The adjustable armature assembly of claim 2, wherein the armature hub comprises a plurality of arms extending from the coupling plate, and wherein the armature assembly comprises a respective control lock washer and control pin for each arm of the plurality of arms.

13. The adjustable armature assembly of claim 1, further comprising a control lock disc coupled between the armature hub and the armature plate, wherein the control lock disc comprises a pin hole, and wherein the control lock disc is mounted to reciprocate on the control pin via the pin hole.

14. The adjustable armature assembly of claim 13, wherein the armature hub comprises a neck with an outer surface, wherein the outer surface is ribbed, wherein the control lock disc comprises an annular body and an interior flange, and wherein the armature plate is configured to irreversibly walk out away from the armature hub by pulling the control pin head against the control lock disc and walking the flange over the ribbed outer surface when the armature assembly is engaged.

15. A clutch assembly comprising the adjustable armature assembly of claim 1, the clutch assembly further comprising a rotor assembly configured for rotation and a magnet assembly configured to engage the armature assembly by attracting the armature plate towards the rotor assembly.

16. The clutch assembly of claim 15, wherein the rotor assembly comprises a coupling surface that is configured to wear down when the armature plate couples to the coupling surface, and wherein the armature plate irreversibly walks out away from the armature hub when the coupling surface wears down.
